(19) United States
(12) Patent Application Publication
(10) Pub. No.: US 2008/0278390 A1
(43) Pub. Date: Nov. 13, 2008

(54) Ultra Wide Band Notch Antenna Assembly for Rf Communication Equipment

(75) Inventors: Peter J. Massey, Horley (GB); Kevin R. Boyle, Horsham (GB); Antonius J.M. De Graauw, Haelen (NL); Martijn Udink, Nijmegen (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/159,959

(22) PCT Filed: Dec. 22, 2006
(86) PCT No.: PCT/IB06/55018

§ 371 Date: Jul. 29, 2008

(30) Foreign Application Priority Data
Jan. 2, 2006 (EP) 06300004.6

(51) Int. Cl. H01Q 5/00; H01Q 1/00

(52) U.S. Cl. 343/722; 343/700 MS

(57) ABSTRACT

Abstract: A planar antenna assembly (AA) for an RF communication module, comprises i) a conductive plate having a first linear side of a first length and in which is defined a first notch (N1) of a first width and a first electrical length, equal to a quarter of a wavelength corresponding to a chosen frequency of a working frequency band, and comprises a straight part having an open end (OE1) found on the first side, and a shortened end (SE1), and ii) a first feed line (FL1) defined above the conductive plate and across the first notch (N1) and arranged to be coupled to this first notch (N1) to enable wideband operation. The first length of the first side is equal to half this wavelength. Moreover, the first notch open end (OE1) is present approximately in the middle of the first side. Moreover, the first width of the first notch (N1) is chosen such that the proportion of energy stored in the fields associated with the first notch (N1) is low compared with the result of the chosen frequency times the power radiated from the currents propagating around the first notch.

### FIELD OF THE INVENTION

The present invention relates to the domain of radio-frequency (RF) communication equipment, and more precisely to a planar antenna assembly comprised in, or connected to, RF communication equipments, and in particular for ultra wideband (UWB) applications.

By “communication equipment” is meant here any equipment, mobile or not, adapted to receive and/or transmit RF signals to and/or from mobile (or cellular) and/or WLAN and/or broadcast and/or positioning networks, and notably a mobile phone (for instance a GSM/GPRS, UMTS or WiMax mobile phone), a personal digital assistant (PDA), a laptop, a PCMCIA card (giving an UWB functionality to a laptop or other equipment, such as a monitor or a printer), a USB dongle (for use in computers and their peripherals), a satellite positioning device (for instance a GPS one), a television receiver, or more generally an RF communication module.

### BACKGROUND OF THE INVENTION

As is known by the man skilled in the art, a (planar) notch antenna usually comprises a notch defined in a conductive plate (having a first side with a first length), and a feed line defined above the conductive plate and across the notch and arranged to be electromagnetically coupled to the notch to enable wideband operation. The notch has a first width and a first electrical length (which is equal to a quarter of a wavelength corresponding to a chosen frequency of a working frequency band) and comprises a straight part having an open end found in the first side, and a shortened end.

Because of the very small physical dimensions of the notch, the conductive plate in which it is defined can be a ground plane of a printed circuit board (PCB), mounted in a communication module or communication equipment and comprising generally electronic circuits. Examples of such an arrangement are described in the patent documents US 2002/0037739 and U.S. Pat. No. 6,424,300, and in the publication by S. I. Latif et al “Bandwidth Enhancement and Size Reduction of Microstrip Slot Antennas”, IEEE Transactions on Antennas and Propagation, Vol. 53, No. 3, March 2005, pp. 994-1003. In a variant, the conductive plate may also be part of a module mounted on a face of the PCB. An example of such an arrangement is described in the patent document US 2002/0177416.

Such (planar) notch antennas being easy to manufacture, they are used in (or with) low-cost (and low-profile) communication equipment, notably in aircraft, where the space is limited.

Because of their respective arrangements the notch antennas known in the art cannot offer a very wide working (or operating) frequency band, such as the one required in UWB OFDM (“Orthogonal Frequency Division Multiplex”), for instance, and/or consume too much space on the PCB in which they are defined. It is recalled that UWB OFDM (defined by the Multiband OFDM Association (MBOA)) requires that communication equipment or module works in several 528 MHz wide bands (for instance from 3168 MHz to 4752 MHz in case of three bands, or from 3168 MHz to 4752 MHz and from 6172 MHz to 8184 MHz in case of seven bands).

So the object of the present invention is to improve the situation.

### SUMMARY OF THE INVENTION

For this purpose, it provides a planar antenna assembly, for an RF communication module (or communication equipment), comprising:
a conductive plate having a first linear side of a first length and in which is defined a first notch of a first width and a first electrical length (equal to a quarter of a wavelength corresponding to a chosen frequency of a working frequency band) and comprising a straight part comprising an open end present on the first side, and a shortened end, and
a first feed line defined above the conductive plate and across the first notch and arranged to be coupled to the first notch to enable wideband operation.

This planar antenna assembly is characterised in that:
the first length of the first side is equal to half the wavelength (corresponding to the chosen frequency of the working frequency band),
the first notch open end is found approximately in the middle of the first side, and
the first width (of the first notch) is chosen such that the proportion of energy stored in the fields associated with the first notch is low compared with the result of the chosen frequency times the power radiated from the currents propagating around the first notch.

The planar antenna assembly according to the invention may have additional characteristics considered separately or in combination, and in which notably:
the first width (of the first notch) is smaller than 3 millimeters;
the first side may have a first length equal to half a first wavelength corresponding to the center of a first working frequency band. At least one second notch is defined in the conductive plate approximately in the middle of one of the two halves located on the right and left sides of the first notch. This second notch comprises a straight part parallel to the straight part of the first notch and comprises an open end present on this first side, and a shortened end, and has a second electrical length smaller than the first electrical length. Moreover, a second feed line is defined above the conductive plate and across the second notch and arranged to be coupled to this second notch to enable said wideband operation;
   the second notch may have a second width smaller than the first width;
each feed line may be extended by a series capacitor;
   each series capacitor may have a width larger than the width of the corresponding feed line;
the conductive plate may be mounted on a printed circuit board (PCB) having a dielectric substrate with first and second opposite faces.
   the conductive plate may be mounted on the first face of the substrate, and each feed line may be defined on the second face of the substrate;
      the substrate may have a thickness smaller than the first width of the first notch such that the first notch has a minimal dielectric loading;
      in a variant, the substrate may be cut out in at least part of its thickness between each notch and its second face in order to define a hole filled with air and such that the first notch has a reduced dielectric loading. For instance, the substrate may be cut out in its whole thickness between each notch and its second face;
   the conductive plate may be part of a module mounted on the first face of the substrate and arranged such that the conductive plate is suspended above the first face and parallel to it in an area devoid of conductive plate.

In this case, the conductive plate of the module faces the first face of the substrate and comprises each notch, and each feed line is defined on an upper surface of the module M, opposite to the conductive plate and above and across the corresponding notch;
each notch may be a straight notch or may have an “L” shape.

The invention also provides an RF communication module provided with a planar antenna assembly such as the one introduced above. Such an RF communication module may be incorporated in RF communication equipment.

The invention further provides RF communication equipment provided with a planar antenna assembly such as the one introduced above.

### BRIEF DESCRIPTION OF THE DRAWINGS

Other features and advantages of the invention will become apparent on examining the detailed specifications hereafter and the appended drawings, wherein:

FIG. 1 schematically illustrates in a top plan view a first example of an embodiment of a planar antenna assembly according to the invention,

FIG. 2 is a cross section through axis AA of the first example of the embodiment illustrated in FIG. 1,

FIG. 3 schematically illustrates a first variant of FIG. 2,

FIG. 4 schematically illustrates a second variant of FIG. 2,

FIG. 5 schematically illustrates an antenna impedance response curve on a Smith chart forming kinks and loops across a frequency band including 4 GHz (linear markers are placed at 3, 4 and 5 GHz),

FIG. 6 schematically illustrates in a top plan view a second example of an embodiment of a planar antenna assembly according to the invention,

FIG. 7 schematically illustrates an antenna impedance response curve on a Smith chart forming kinks and loops across a frequency band including 3 GHz (linear markers are placed at 3, 4 and 5 GHz),

FIG. 8 schematically illustrates in a top plan view a third example of an embodiment of a planar antenna assembly according to the invention,

FIG. 9 schematically illustrates in a top plan view a fourth example of an embodiment of a planar antenna assembly according to the invention,

FIG. 10 schematically illustrates in a top plan view a fifth example of an embodiment of a planar antenna assembly according to the invention.

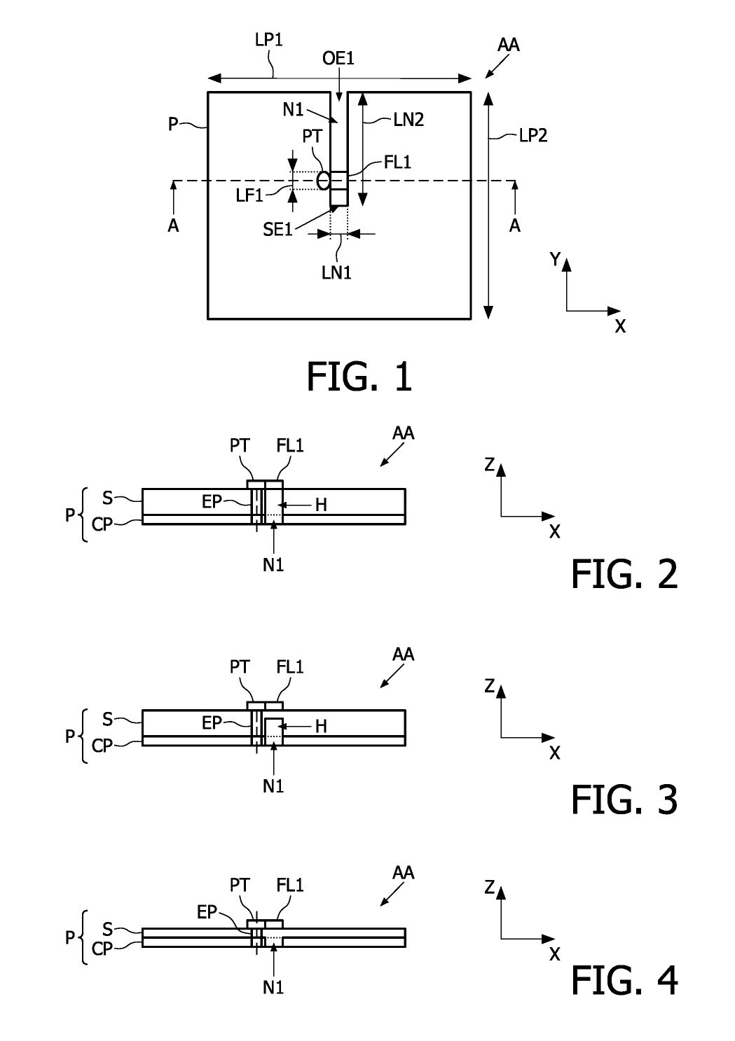

The appended drawings may not only serve to complete the invention, but also to contribute to its definition, if need be. It is important to notice that the relative dimensions of the elements, defining in combination the planar antenna assembly in the FIGS. 1 to 8, are not representative of their respective and real dimensions.

### DESCRIPTION OF THE PREFERRED EMBODIMENTS

Reference is initially made to FIGS. 1 to 4 to introduce the main characteristics of a planar antenna assembly AA according to the invention.

In the following description it will be considered that the planar antenna assembly AA is intended for RF communication equipment such as a mobile phone, for instance a UMTS phone. But it is important to note that the invention is not limited to this type of RF communication equipment.

Indeed the invention may apply to any RF communication equipment or module, mobile or not, adapted to receive and/or transmit RF signals to and/or from mobile (or cellular) and/or WLAN and/or broadcast and/or positioning networks. So it could also be a personal digital assistant (PDA), a laptop, a satellite positioning device (for instance a GPS one), a dongle or a television receiver. It may apply to any single standard or multi-standard combination, and notably to a GSM/GPRS and/or UMTS/TD-SCDMA and/or WiMax and/or WLAN (e.g. 802.11a/b/g/n) and/or broadcast (e.g. DVB-H and DAB) and/or positioning (e.g. GPS) combination.

The invention may be notably used in the consumer equipment (or modules) and more especially in the wireless equipments (or modules) adapted to short range high data rate communications, such as the ones required for rapid file transfers and video transmission. Moreover, the invention may be provided in a UWB dongle, for instance of the USB type, intended for adding functionality to personal computers or any other devices with USB connectors.

As illustrated in FIGS. 1 and 2, a planar antenna assembly AA comprises at least a conductive plate CP, having at least one notch N1, and at least a first feed line FL1, capacitively coupled to the corresponding notch N1.

In the following description it will be considered that the conductive plate CP has a rectangular shape. But this is not mandatory.

In this case, the conductive plate CP has first and second parallel (linear) sides extending at least on a first length LP1 (parallel to the X direction), and third and fourth parallel sides extending on a second length LP2 (parallel to the Y direction) and perpendicular to the first and second sides.

A first notch N1 is defined in the conductive plate CP. This first notch N1 comprises at least a straight part having an open end OE1 which is found (or freely abuts) on the first side, and a shortened end SE1. In the example shown, the straight part is approximately parallel to the third and fourth sides (and therefore to the Y direction). But this is not mandatory. The first notch N1 has a first width LN1 (in the X direction) and a first electrical length LN2 (in the Y direction). In the example of embodiment illustrated in FIG. 1, the first notch N1 is straight, i.e. it extends in the Y direction. But it may be folded (“L”-shaped) as will be explained below with reference to FIG. 6.

It is recalled that the first electrical length LN2 may be different from the physical length LN2. This effectively depends on the dielectric environment of the first notch N1. In the case where the conductive plate CP (and then the first notch N1) is separated from the feed line FL1 by a dielectric substrate S, the first electrical length LN2 is larger than the physical length LN2.

The first feed line FL1 is defined above the conductive plate CP and across the first notch N1. As will be explained below, it is arranged to be capacitively coupled to the first notch N1 to enable a wideband operation. It may be a 50Ω microstrip. The first feed line FL1 is fed through a port terminal PT, which is connected to a 50Ω excitation probe EP (for instance a coaxial cable), as illustrated in FIGS. 2 to 4, and feeds the first notch N1 by capacitive coupling.

The conductive plate CP may be the ground plane of a printed circuit board (PCB) P, as illustrated in FIGS. 1 to 7. But this is not mandatory. When the conductive plate CP is the ground plane of a PCB P, it is mounted on a first (rear) side of a dielectric substrate S, while the first feed line FL1 is defined on a second (front) face of this dielectric substrate S, opposite the first face.

According to the invention, the planar antenna assembly AA must present at least the following combination of technical characteristics:
the first electrical length LN2 of the first notch N1 must be equal to a quarter of a wavelength (λ/4), which corresponds to a chosen frequency (f) of a working (or operating) frequency band,
the first length LP1 of the first and second sides must be equal to half the wavelength (λ/2), which corresponds to the chosen frequency (f) of the working (or operating) frequency band,
the open end OE1 of the first notch N1 must be present approximately in the middle of the first side (i.e. at +/−15%), and
the first width LN1 of the first notch N1 is chosen such that the proportion of energy stored in the fields associated with the first notch N1 is low compared with the result of the chosen frequency (f corresponding to λ) times the power which is radiated from the currents propagating around the first notch N1.

The frequency f which corresponds to the wavelength λ may be for instance the center frequency of the working (or operating) frequency band. But this is not mandatory.

The length of the first notch N1, equal to a quarter wavelength λ/4, induces a first resonance (i.e. high intensity currents) around the first notch N1, and more precisely from one of its sides to the other one. There is also a second resonance associated with currents across the conductive plate CP in the direction of the first length LP1, because the latter is equal to half the chosen wavelength λ/2. Thus the notch feed line FL1 is coupled both to the (first) notch resonance and to the (second) resonance across the conductive plate CP, which causes the radiation.

For efficient radiation, the currents associated with the notch resonance should extend away from the first notch N1. However, the opposing conducting sides of the slot line forming the first notch N1 give rise to a capacitance across the slot. This capacitance tends to attract the currents around the first notch N1. Consequently, the narrower the first notch N1, the larger its capacitance per unit length, and therefore the greater the concentration of current in the immediate vicinity of the first notch N1. Hence with a narrower first notch N1, the notch radiates less but has a higher radiation quality factor. For high radiation quality factor notches, the radiation and hence the bandwidth can be improved by a small increase of the first width LN1 of the first notch N1.

The width of the operating frequency band is optimized when the open end OE1 of the first notch N1 is found approximately in the middle of the first side.

In an advantageous embodiment, the first width LN1 of the first notch N1 is chosen smaller than 3 millimeters, and preferably smaller than or equal to 2 millimeters (≦2 mm). This allows to minimize the area which is occupied by the first notch N1 on the PCB P.

As mentioned before, the value of the first electrical length LN2 depends whether a dielectric substrate S is inserted or not between the first notch N1 and the first feed line FL1. Three cases can be envisaged.

The first case is illustrated in FIG. 2. It corresponds to a situation in which the substrate S is fully cut out in its thickness (in the Z direction) between the first notch N1 and its second (front) face on which the first feed line FL1 is defined. In this case a hole H, filled with air, is defined in the substrate S to confer a small dielectric loading to the first notch N1.

The second case is illustrated in FIG. 3. It corresponds to an intermediate situation in which the substrate S is partly cut out in its thickness (in the Z direction) between the first notch N1 and its second (front) face on which the first feed line FL1 is defined. In this case a small hole H, also filled with air, is defined in the substrate S to apply an intermediate dielectric loading to the first notch N1. The value of the intermediate loading depends on the remaining thickness of the substrate S between the first notch N1 and the first feed line FL1.

In the first and second cases, the first feed line FL1 is “suspended” across the hole H.

The third case is illustrated in FIG. 4. It corresponds to a situation in which the substrate S is not cut out between the first notch N1 and its second (front) face on which the first feed line FL1 is defined. In this case the dielectric loading of the first notch N1 is maximal. But, it is also possible to get a minimal dielectric loading by using a substrate S having a thickness smaller than the first width LN1 of the first notch N1.

If the dielectric loading of the first notch N1 is increased, the ratio of the electrical length to the physical length is increased. Therefore, for a fixed center frequency of the operating band, increasing the dielectric loading results in a shorter first physical length LN2 of the first notch N1 and a smaller width of the operating frequency band. When the dielectric loading of the first notch N1 is decreased, its first physical length LN2 must be increased, and the bandwidth increases.

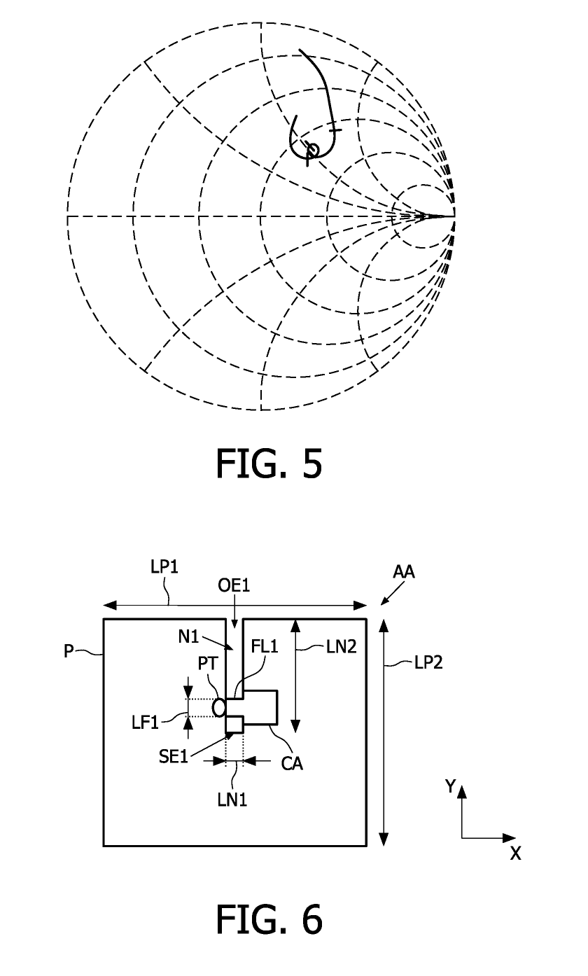

For instance, to get a resonance around 4 GHz when the substrate has been cut out (or removed), as exemplified by the antenna impedance response curve plotted on a Smith chart forming kinks and loops across a frequency band that includes 4 GHz (such as the one illustrated in FIG. 5), one may use:
a PCB having a first length LP1 equal to 44 mm and a second length LP2 equal to 40 mm, and comprising a substrate S of the FR4 type (epoxy-based with a dielectric constant taken to be 4.4 and a dielectric loss tangent assumed to be equal to 0.02) with a 0.8 mm thickness, and a thin conductive plate CP in copper with a 0.035 μm thickness,
a first notch N1 having a first length LN2 equal to 18 mm and a first width LN1 equal to 1 mm, and
a first feed line FL1 with a center-line located at 5 mm from the shortened end
SE1 of the first notch N1 and having a width LF1 equal to 1.5 mm.

When the space is limited, which is often the case on a PCB P, the first physical length LN2 of the first notch N1 must be reduced. So, to compensate for the width reduction of the operating frequency band while matching the first feed line FL1 to 50Ω, it is preferable to extend the first feed line FL1 with a series capacitor CA, as illustrated in FIG. 6. This series capacitor CA can be a microstrip patch which is preferably wider than the first feed line FL1 to increase the capacitance per unit length.

For instance, when the substrate has been fully cut out (or removed) and in order to match an antenna to 50Ω across a wide bandwidth that includes 3 GHz, one may use:
a PCB having a first length LP1 equal to 44 mm and a second length LP2 equal to 40 mm, and comprising a substrate of the FR4 type (epoxy-based with a dielectric constant taken to be 4.4 and a dielectric loss tangent assumed to be equal to 0.02) with a 0.8 mm thickness, and a thin conductive plate in copper with a 0.035 μm thickness,
a first notch N1 having a first length LN2 equal to 18 mm and a first width LN1 equal to 1 mm, and
a first feed line FL1 located approximately at 5 mm from the shortened end SE1 of the first notch N1 and having a width FL1 equal to 1.5 mm, extended by a 3 mm×3 mm series capacitor CA corresponding to a capacitance between 0.6 pF and 0.7 pF.

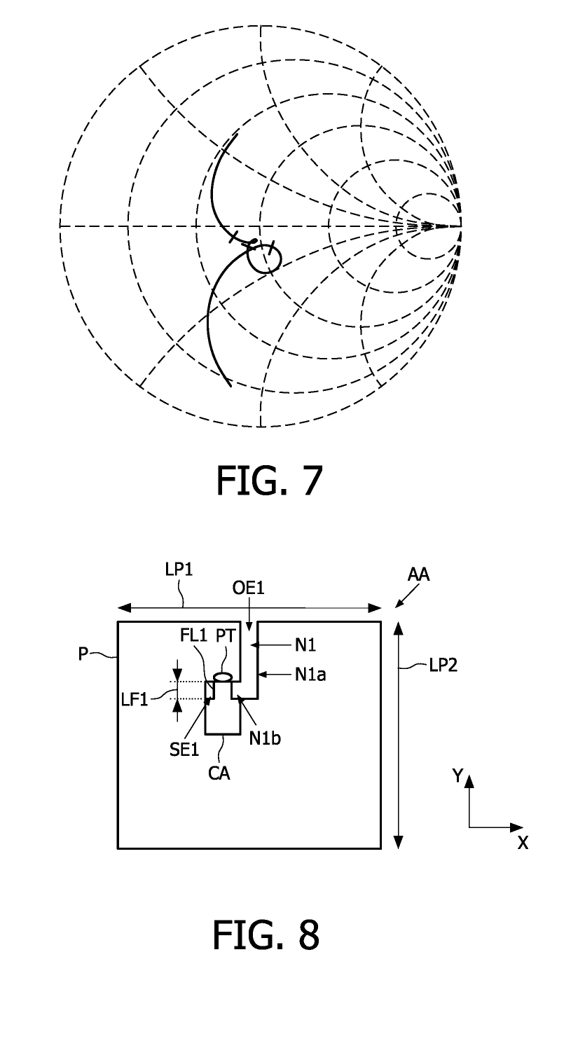

A Smith chart of this example of embodiment is illustrated in FIG. 7.

When the space in the Y direction is limited, it is possible to use a first notch N1 with an “L” shape instead of a straight notch. The L shape forces much of the currents to take a longer path and to spread further on the conductive plate CP. This situation is schematically illustrated in FIG. 8.

In this case, the folded first notch N1 comprises a first part N1a, which extends in the Y direction and comprises the open end OE1, and a second part N1b, which extends in the X direction and comprises the shortened end SE1.

For instance, to get a resonance around 3 GHz when the substrate has not been cut out (or removed), one may use:
a PCB having a first length LP1 equal to 34 mm and a second length LP2 equal to 20 mm, and comprising a substrate of the FR4 type with a 0.8 mm thickness, and a thin conductive plate in copper with a 0.035 μm thickness,
a first notch N1 having a first part N1 with a 10 mm length, a second part with a 8 mm length, and a first width LN1 equal to 1 mm, and
a first feed line FL1 located approximately at 2.5 mm from the shortened end SE1 of the second part N1b of the first notch N1 and having a width FL1 equal to 1.5 mm, extended by a series capacitor CA corresponding to a capacitance approximately equal to 1 pF, followed by an inductance of approximately 2 nH and by another capacitance corresponding to a capacitance approximately equal to 2.1 pF and coupled to the excitation probe.

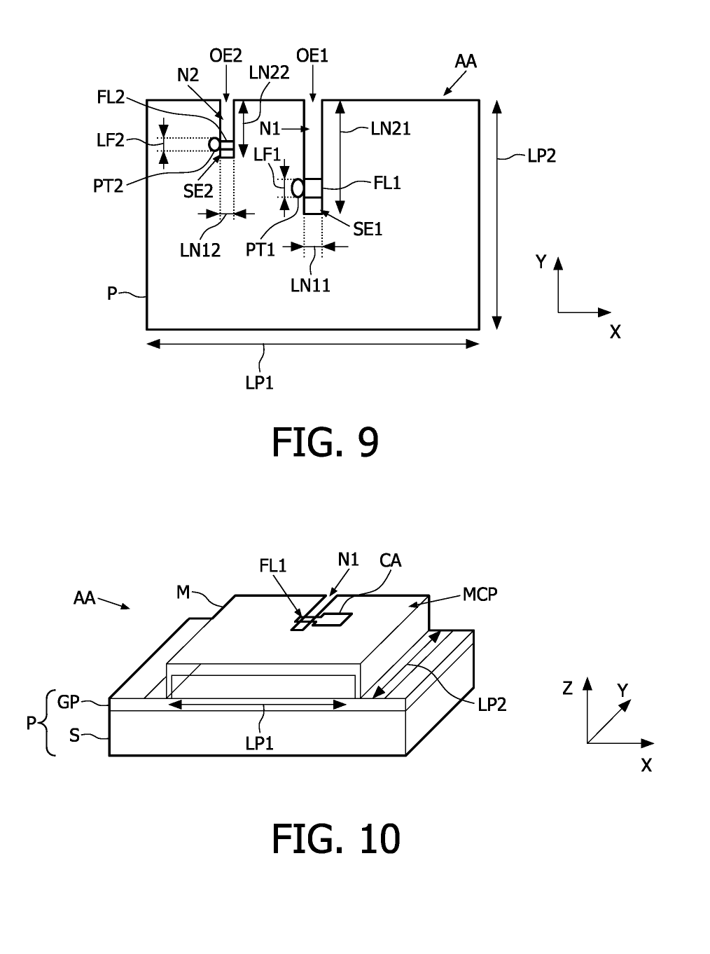

A (planar) notch antenna assembly AA with a single (first) notch N1 can cover approximately a 2:1 bandwidth (it is recalled that an n:m bandwidth refers to the ratio of the upper frequency n of the band to the lower frequency m of this band). So, in order to cover the whole 3:1 bandwidth, for instance of a 3.1 GHz to 10.6 GHz FCC specified UWB band, the planar antenna assembly AA must comprise at least first N1 and second N2 notches electromagnetically coupled to first FL1 and second FL2 feed lines, respectively. This situation is schematically illustrated in FIG. 9.

In this case the first and second sides have a full length LP1 (in the X direction). A second notch N2 is defined in the conductive plate CP. It comprises a straight part which is parallel to the straight part of the first notch N1. This second notch N2 has a second electrical length LN22 which is smaller than the first electrical length LN12 of the first notch N1 and a second width LN21 which is smaller than the first width LN11 of the first notch N1.

The first notch N1 shares its active space with the second notch N2 and acts as a demarcation of one edge of half-wavelength across the planar antenna assembly AA (and for instance across the PCB P) for the second notch N2. This results in a very compact structure. For instance, the first notch N1 may cover the sub 5 GHz frequencies (3.1 GHz to 5 GHz) while the second notch N2 may cover the frequencies beyond 6 GHz (6 GHz to 10.6 GHz).

The planar antenna assembly AA must be as follows:
the first electrical length LN21 of the first notch N1 must be equal to a quarter of a first wavelength (λ1/4), which corresponds to the center frequency (f1) of the lower operating (or working) frequency band,
the first length LP2 of the first and second sides must be equal to half the first wavelength (λ1/2) and equal to a second wavelength (λ2), which corresponds to the center frequency (f2) of the upper operating (or working) frequency band,
the open end OE1 of the first notch N1 must be present approximately in the middle of the first side (i.e. at +/−15%),
the first width LN111 of the first notch N1 is chosen such that the proportion of energy stored in the fields associated with the first notch N1 is low compared with the result of the center frequency (f1 corresponding to λ1) times the power that is radiated from the currents propagating around the first notch N1,
the second electrical length LN22 of the second notch N2 must be equal to a quarter of the second wavelength (λ2/4), and
the open end OE2 of the second notch N2 must be present approximately in the middle of the half of the first side which is located either on the right or the left of the first notch N1 (i.e. at +/−15%).

In an advantageous embodiment, the first width LN11 of the first notch N1 is smaller than 3 millimeters and preferably smaller than or equal to 2 millimeters (≦2 mm). This allows to minimise the area which is occupied by the first N1 and second N2 notches on the PCB.

The second width LN12 of the second notch N2 can be smaller than the first width LN11 of the first notch N1. But this is not mandatory.

The first FL1 and second FL2 feed lines are defined above the conductive plate CP and across the first N1 and second N2 notches, respectively. Each feed line FL1 or FL2 is arranged to be coupled to the corresponding notch N1 or N2 to enable an ultra wideband operation. They may be 50Ω microstrips. The first FL1 and second FL2 feed lines are fed through first PT1 and second PT2 port terminals respectively, which are connected to 50Ω excitation probes (not shown).

In the example of embodiment illustrated in FIG. 9, the first N1 and second N2 notches are straight, i.e. they extend in the Y direction. But they may be folded (“L”-shaped) as explained before with reference to FIG. 8. In this case, the orientation of the notches N1 and N2 may be the same. But the notches may also have opposite orientations.

As mentioned before, with reference to FIGS. 2 to 4, the substrate S may be fully or partly removed (or cut out) between the notches N1 and N2 and the corresponding feed lines FL1 and FL2 or may be kept.

For instance, when the substrate has been removed (or cut out), one can use:
a PCB having a first length LP1 equal to 44 mm and a second length LP2 equal to 40 mm, and comprising a substrate of the FR4 type with a 0.8 mm thickness, and a thin conductive plate in copper with a 0.035 μm thickness,
a first notch N1 having a first length LN21 equal to 18 mm and a first width LN11 equal to 1 mm,
a first feed line FL1 located at 6 mm from the shortened end SE1 of the first notch N1 and having a width FL1 equal to 1.5 mm, and extended by a 3.5 mm×3.5 mm series capacitor CA,
a second notch N2 having a second length LN22 equal to 7 mm and a second width LN12 equal to 0.5 mm, and
a second feed line FL2 located at 2.5 mm from the shortened end SE2 of the second notch N2 and having a width FL2 equal to 1.5 mm, and extended by a 1.7 mm×1.7 mm series capacitor CA.

The excitation probes (EP) can be fed by separate transceivers. In this case, a first transceiver covers the lower operating frequency band (for instance from 3.1 GHz to 5 GHz) and is connected to the first feed line FL1 coupled to the (longer) first notch N1, and a second transceiver covers the upper operating frequency band (for instance from 6 GHz to 10.6 GHz) and is connected to the second feed line FL2 coupled to the (shorter) second notch N2.

Alternatively, the excitation probes (EP) can be fed by a single UWB transceiver. In this case a diplexer can be used to simultaneously connect the transceiver to the (longer) first notch N1, for instance for 3.1 GHz to 5 GHz operation, and to the (shorter) second notch N2, for instance for 6 GHz to 10.6 GHz operation.

It is important to note that more than two notches (for instance three or even four) can be defined in the ground plane CP in order to still increase the operating (or working) frequency band. For instance a third notch is parallel to the first N1 and second N2 notches, has an open end which is present approximately in the middle of the part of the first side which is located on the left side of the second notch N2 (i.e. at +/−15%), has a (third) electrical length equal to a quarter of a third wavelength (λ3/4) which corresponds to the center frequency (f3) of an upper operating (or working) frequency band, and may have a (third) width smaller than the second width LN12 of the second notch N2 (but this is not mandatory).

Moreover, it is also possible to use a “demarcation” notch without any feed line such that it only acts as a demarcation of one edge of half-wavelength across the planar antenna assembly AA (and for instance across the PCB P) for another notch coupled to a feed line (according to the invention, such as the first notch N1) and having an open end found approximately in the middle of the half of a side which is located either on the right or left of the demarcation notch without any feed line. In this case the first length LP1 is the length defined between the demarcation notch and the edge of the planar antenna assembly M.

In the above described examples of embodiment, each notch is defined in the ground plane CP of a PCB P. But this is not mandatory. Indeed, the planar antenna assembly AA may comprise a module M mounted on a face of a substrate S (which may be the one of a PCB P) and comprising a conductive plate MCP suspended above this face and parallel to it and in which each notch N1 (or N1 and N2) is defined.

In the case where the module M is mounted on a face of a PCB P, this face is preferably the first (rear) face of the substrate S (on which is mounted the ground plane CP), as illustrated in FIG. 10. More precisely, the conducting plane MCP of the module M is defined on the lower surface of the module (facing the ground plane CP of the PCB P), and there is a region of the PCB P under the module M which is devoid of ground plane (and tracks).

A module of this type is notably described in the patent document US 2002/0177416 cited above. So the way it is mounted on the possible PCB and the way it is arranged will not be described here.

Such a module M can comprise one or more straight or L-shaped notches N1, such as the one above described with reference to FIGS. 1 to 9, defined in its conducting plane MCP. Each feed line FL1 (or FL1 and FL2) is defined on the upper surface of the module M (opposite to its lower surface). In this case, the feed line FL1 may consist of two components (an inductor and a capacitor (such as the one above described with reference to FIGS. 1 to 9)) placed across the notch N1.

The invention is not limited to the embodiments of planar antenna assembly AA and RF communication equipment or module described above, only as examples, but it encompasses all alternative embodiments which may be considered by one skilled in the art to be within the scope of the claims hereafter.

It must be understood that all wavelength dimensions given in the claims must be interpreted in the way of a skilled man's use, commonly taking into account various parameters, which does not disturb the magnitude of them.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

1. A planar antenna assembly for an RF communication module, comprising i) a conductive plate having a first linear side of a first length, and in which is defined a first notch with a first width and a first electrical length, equal to a quarter of a wavelength corresponding to a chosen frequency of a working frequency band, and comprising a straight part comprising an open end found on said first side, and a shortened end, and ii) a first feed line defined above said conductive plate and across said first notch and arranged to be coupled to said first notch to enable wideband operation, characterised in that said first length of said first side is equal to half said wavelength, in that said first notch open end found approximately in the middle of said first side, and in that said first width of said first notch is chosen such that the proportion of energy stored in the fields associated with said first notch is low compared with the result of the chosen frequency times the power radiated from the currents propagating around said first notch.

2. Planar antenna assembly according to claim 1, wherein the first width is smaller than 3 millimeters.

3. Planar antenna assembly according to claim 1, wherein the first side has a first length equal to half a first wavelength corresponding to the center of a first working frequency band, in that it comprises i) at least one second notch defined approximately in the middle of one of two halves of said conductive plate located on the right and left sides of said first notch, which comprises a straight part parallel to the straight part of said first notch and comprises an open end found on said first side, and a shortened end, and has a second electrical length smaller than said first electrical length, and ii) a second feed line defined above said conductive plate and across said second notch and arranged to be coupled to this second notch to enable said wideband working.

4. Planar antenna assembly according to claim 3, wherein the second notch has a second width smaller than said first width.

5. Planar antenna assembly 4 according to claim 1, wherein each feed line is extended by a series capacitor.

6. Planar antenna assembly according to claim 5, wherein each series capacitor (CA) has a width larger than the width of the corresponding feed line.

7. Planar antenna assembly, accordingly claim 1 wherein the conductive plate is mounted on a printed circuit board having a dielectric substrate with first and second opposite faces.

8. Planar antenna assembly according to claim 7, wherein the conductive plate is mounted on said first face of said substrate, and each feed line is defined on said second face of said printed circuit board substrate.

9. Planar antenna assembly according to claim 8, wherein the substrate has a thickness smaller than said first width of said first notch such that said first notch has a minimal dielectric loading.

10. Planar antenna assembly according to claim 8, wherein the substrate is cut out in at least a part of its thickness between each notch and its second face in order to define a hole filled with air and such that said notch has a reduced dielectric loading.

11. Planar antenna assembly according to claim 10, wherein the substrate is cut out in its whole thickness between each notch and its second face.

12. Planar antenna assembly according to claim 7, wherein it comprises a module mounted on said first face of said substrate, comprising a conductive plate facing said first face and in which each notch is defined, and arranged such that said conductive plate is suspended above said first face and parallel to it in an area devoid of conductive plate, and in that each feed line is defined on an upper surface of said module M, opposite to said conductive plate and above and across the corresponding notch.

13. Planar antenna assembly according to claim 1, wherein each notch is a straight notch.

14. Planar antenna assembly according to claim 1, wherein each notch an “L” shape.

15. Radio-frequency communication module, comprising a planar antenna assembly according to claim 1.

16. Radio-frequency communication equipment, comprising a radio-frequency communication module according to claim 15.

17. Radio-frequency communication equipment, comprising a radio-frequency communication module connected to a planar antenna assembly according to claim 1.
